(19) United States
(12) Patent Application Publication
(10) Pub. No.: US 2007/0178299 A1
(43) Pub. Date: Aug. 2, 2007

(54) Water-soluble composition and structures, and methods of making and using the same

(76) Inventor: Andrew P. Verrall, Crown Point, IN (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/491,345

(22) Filed: Jul. 21, 2006

Related U.S. Application Data
(63) Continuation of application No. 11/412,860, filed on Apr. 27, 2006, now abandoned.
(60) Provisional application No. 60/675,764, filed on Apr. 28, 2005.
(60) Provisional application No. 60/687,210, filed on Jun. 3, 2005.

(51) Int. Cl. B32B 5/16

(52) U.S. Cl. 428/323; 428/447; 428/522

(57) ABSTRACT

A plasticized water-soluble composition and structure (e.g., film) including a water-soluble polymer, a hydrophilic nanoscale particulate, a plasticizer, and, optionally, one or more auxiliary agents such as a crosslinking agent for the polymer, plasticizers, surfactants, extenders, and release agents, is disclosed. Also disclosed are containers made from such compositions and films, and methods of making and using such items.

### BACKGROUND

1. Field of the Disclosure

The disclosure relates generally to water-soluble films and other water-soluble structures used for contact with liquids. More particularly, the disclosure relates to such compositions having improved liquid barrier properties.

2. Brief Description of Related Technology

Prior attempts to provide water-soluble films with liquid barrier properties have involved the application of one or more coatings of water-insoluble materials to the films.

Certain polymer/nanoclay composites are known for improving gas barrier properties, fire resistance, heat distortion, and mechanical properties, as compared to the polymers alone.

### SUMMARY

One aspect of the disclosure provides a composition, the composition including a water-soluble polymer, a hydrophilic nanoscale particulate, a solvent, a plasticizer, and, optionally, a crosslinking agent. The composition can be used for making a water-soluble structure, such as a film.

Another aspect of the disclosure provides a water-soluble structure, such as a film, the structure including a water-soluble polymer, a hydrophilic nanoscale particulate, a plasticizer, and, optionally, a crosslinking agent for the polymer.

Yet another aspect of the disclosure provides a container made from the water-soluble composition or film, optionally enclosing a liquid therein.

Still another aspect of the disclosure provides a method of making a water-soluble structure such as a film, including the steps of creating a mixture of a hydrophilic nanoscale particulate, a water-soluble polymer, a solvent, a plasticizer, and, optionally, a crosslinking agent, and then removing the solvent to form a water-soluble structure.

Another aspect of the disclosure provides methods employing the composition, the structure, the film, or the container, including steps of confining a liquid therewith and releasing the liquid under defined conditions, such as temperature and degrees of physical disruption.

Further aspects and advantages will be apparent to those of ordinary skill in the art from a review of the following detailed description. While the compositions, films, articles, and methods are susceptible of embodiments in various forms, the description hereafter includes specific embodiments with the understanding that the disclosure is illustrative, and is not intended to limit the invention to the specific embodiments described herein.

### DETAILED DESCRIPTION

One embodiment is a composition and structure made from the composition, such as a film, which includes a water-soluble polymer, such as polyvinyl alcohol (PVOH), a plasticizer, a nanometer scale hydrophilic particulate, such as sodium montmorillonite, and optionally a crosslinking agent for the polymer, such as boric acid. The structure (e.g., film) has improved liquid barrier properties.

The film embodiment preferably is free-standing, i.e., unattached to any substrate such as in the form of a coating. The film is preferably homogeneous, in the sense of having a single composition, such as a single-layer film, or a multi-ply film formed from the same composition.

The water-soluble polymer preferably is PVOH. Cellulose ethers, such as hydroxypropyl methylcellulose (HPMC), and combinations of water-soluble polymers are also contemplated. The water-soluble polymer preferably is included in the film in a range of about 45% by weight, based on the weight of the film (wt. %) to about 85 wt. %, for example 60 wt. %, about 72 wt. %, or 74 wt. %.

If polyvinyl alcohol or a copolymer thereof is used, then the PVOH can be partially or fully hydrolyzed. Polyvinyl alcohol (PVOH) is a synthetic resin generally prepared by the alcoholysis, usually termed hydrolysis or saponification, of polyvinyl acetate.

Fully hydrolyzed PVOH, where virtually all the acetate groups have been converted to alcohol groups (e.g., 98% or greater degree of hydrolysis), is a strongly hydrogen-bonded, highly crystalline polymer which dissolves only in hot water—e.g., rapid dissolution at temperatures of about 60° C. and greater.

If a sufficient number of acetate groups are allowed to remain after the hydrolysis of polyvinyl acetate, the PVOH polymer then being known as partially hydrolyzed, it is more weakly hydrogen-bonded and less crystalline and is soluble in cold water—e.g., rapid dissolution at temperatures of about 10° C. and greater.

Both fully and partially hydrolyzed PVOH types are commonly referred to as PVOH homopolymers although the partially hydrolyzed type is technically a vinyl alcohol-vinyl acetate copolymer.

An intermediate cold/hot water soluble film can include, for example, blends of partially-hydrolyzed PVOH (e.g., with degrees of hydrolysis of about 94% to about 98%), and is readily soluble only in warm water—e.g., rapid dissolution at temperatures of about 40° C. and greater.

The term PVOH copolymer is generally used to describe polymers that are derived by the hydrolysis of a copolymer of a vinyl ester, typically vinyl acetate, and another monomer. PVOH copolymers can be tailored to desired film characteristics by varying the kind and quantity of copolymerized monomers. Examples of copolymerizations are those of vinyl acetate with a carboxylic acid or with an ester of a carboxylic acid. Again, if the hydrolysis of acetate groups in these copolymers is only partial, then the resulting polymer could also be described as a PVOH terpolymer—having vinyl acetate, vinyl alcohol, and carboxylic acid groups—although it is commonly referred to as a copolymer.

It is known in the art that many PVOH copolymers, because of their structure, can be much more rapidly soluble in cold water than the partially hydrolyzed type of PVOH homopolymers. Such copolymers have therefore found considerable utility in the fabrication of packaging films for the unit dose presentation of various liquid and powdered products including, but not limited to, agrochemicals, household and industrial cleaning chemicals, laundry detergents, water treatment chemicals, and the like.

In one class of embodiments, the film is hot-water-soluble. In one such embodiment contemplated, the film dissolves within 10 minutes in water at 80° C., preferably within 5 minutes. Such a film can include a fully-hydrolyzed PVOH and a crosslinking agent for the PVOH.

In another class of embodiments, the film is cold-water-soluble. In one such embodiment contemplated, the film dissolves within 10 minutes in water at 10° C., preferably within 5 minutes. Such a film can include a partially-hydrolyzed PVOH (e.g., a degree of hydrolysis of about 70% to about 90%; typically about 80% to about 90%) and the crosslinking agent is optional.

In another class of embodiments, the film is intermediate cold/hot-water-soluble or disintegrable. Such a film can include, for example, blends of partially-hydrolyzed PVOH (e.g., with degrees of hydrolysis of about 94% to about 98%) and the crosslinking agent is optional. The intermediate cold/hot-water-soluble film can also be designed to break into pieces in cold or warm water. In one such embodiment contemplated the film breaks into pieces within 20 minutes in water at room temperature, preferably within 10 minutes, such as for flushable applications.

The hydrophilic nanoscale particulate is selected from the group of natural layered silicate materials (clays), including the smectite family of nanoclays, synthetic layered silicates (e.g., LAPONITE clay, available from Laporte Industries Plc, UK), nanocrystalline main group metal oxides, nanocrystalline rare earth oxides, nanocrystalline transition metal oxides, nanocrystalline mixed oxides of the foregoing; nanocrystalline main group metal phosphates and phosphonates, nanocrystalline transition metal phosphates and phosphonates, and nanocrystalline alkaline earth metal phosphates and phosphonates; nanocrystalline chalcogenide compounds; nanocrystalline fullerene aggregates, and combinations of any of the foregoing.

Preferred are hydrophilic nanoclays selected from the smectite family of nanoclays (e.g., aliettite, beidellite, hectorite, montmorillonite, nontronite, saponite, sauconite, stevensite, swinefordite, volkonskoite, yakhontovite, and zincsilite). More preferred is a montmorillonite such as sodium montmorillonite. Sodium montmorillonite is available under the trade name CLOISITE NA from Southern Clay Products, Inc., of Gonzales, Tex. Montmorillonite clay naturally forms stacks of plate-like structures, or platelets. The spaces between these platelets are called gallery spaces. Under the proper conditions, the gallery spaces can be filled with the water-soluble polymer. This increases the distance between the platelets (the d-spacing), swelling the clay. Clay platelets swollen with polymer are said to be intercalated. If the clay swells so much that it is no longer organized into stacks, it is said to be exfoliated.

In one type of embodiment, it is contemplated to employ a nanoscale particulate having an average platelet thickness of up to about 10 nanometers and an aspect ratio of at least about 50. For example, an average platelet thickness of about 1 nm to about 10 nm, and height and width each independently from about 50 nm to about 1.5 microns. For example, the aspect ratio may be from about 100 to about 1000, or from about 100 to about 500. CLOISITE NA sodium montmorillonite nanoclay is believed to have a nominal particle size of about 7 microns, with a particle size distribution from about 1 micron to about 15 microns. The individual CLOISITE NA sodium montmorillonite nanoclay platelet is believed to be about 1 nm thick and have an average diameter of about 70 nm to about 150 nm. The d-spacing of CLOISITE NA is believed to be approximately 12 Å. In the films of the invention, the nanoscale particulate platelets are preferably at least intercalated or they may be exfoliated. Methods of intercalation, exfoliation and homogenous dispersion into a polymer are known in the art. For example, a process of exfoliation and homogenous dispersion into a water-soluble polymer can include shear mixing, wherein shear rate and residence time can be varied to achieve the desired result.

The hydrophilic nanoscale particulate preferably is present in an amount up to about 10 wt. % or less than 10 wt. %, for example about 1 wt. % to about 10 wt. %, or 6 wt. % % to about 10 wt. % based on the weight of the film. For example, sodium montmorillonite can employed in an amount of about 7 wt. % or about 10 wt. % for a hot-water-soluble PVOH film, and about 4 wt. % for a cold-water-soluble PVOH film. Other embodiments are contemplated to employ relatively low levels of nanoscale particulates, including nanoclays, such as about 5 wt. % or less, less than 5 wt. %, about 4 wt. % or less, less than 4 wt. %, 1 wt. % to 5 wt. %, and 1 wt. % to 4 wt. %.

For PVOH as the water-soluble polymer, the crosslinking agent may be any chemical agent that can form chemical bonds with the hydroxyl groups of PVOH. Such crosslinking agents include, but are not limited to, monoaldehydes (e.g., formaldehyde and hydroxyacetaldehyde), dialdehydes (e.g., glyoxal, glutaraldehyde and succinic dialdehyde), aldehyde-containing resins (e.g., trimethylol melamine), dicarboxylic acids (e.g., maleic, oxalic, malonic and succinic acids), citric acid, glycidyl and other difunctional methacrylates, N-lactam carboxylates, dithiols (e.g., m-benzodithiol), boric acid and borates, ammonium zirconium carbonate, inorganic polyions (e.g., molybdate and tungstate), cupric salts and other Group 1B salts, polyamide-epichlorohydrin resin (polyazetidine prepolymer), and combinations of any of the foregoing.

Rather than those crosslinking agents which undergo direct condensation reactions with hydroxyl groups (such as esterification and acetalization reactions with carboxylic acids and aldehydes, respectively), preferred crosslinking agents—for reasons of ultimate film solubility—are those that have one or more of the following functionalities: those that form complexes via labile polar covalent interactions, those that crosslink via ionic interactions, those that crosslink via hydrogen bonding interactions, and combinations of such crosslinking agents. Examples of such preferred crosslinking agents are borates, boric acid, ammonium zirconium carbonate, inorganic polyions such as molybdate and tungstate, cupric salts and other Group 1B salts, and polyamide-epichlorohydrin resin, and combinations thereof.

Particularly preferred crosslinking agents for PVOH are boric acid and polyamide-epichlorohydrin resin. A preferred water-soluble polyamide-epichlorohydrin is available under the trade name POLYCUP 172 (12% resin) by Hercules, Inc. of Wilmington, Del.

The crosslinking agent preferably is present in an amount up to about 10 wt. %, for example about 1 wt. % to about 10 wt. %, or 5 wt. % to about 10 wt. % based on the weight of the film. For example, water-soluble polyamide-epichlorohydrin resin preferably is used in an amount of about 7 wt. % with PVOH. As another example, boric acid is preferably used in an amount of about 5 wt. % with PVOH.

The film composition and film can contain other auxiliary film agents and processing agents, such as, but not limited to, plasticizers, lubricants, release agents, fillers, extenders, antiblocking agents, detackifying agents, antifoams and other functional ingredients, for example in amounts suitable for their intended purpose.

Embodiments including plasticizers are preferred, for example glycerin. With PVOH, for example, in preferred embodiments glycerin is used in an amount from about 10 wt. % to about 15 wt. %, for example about 11 wt. %, about 12 wt. %, or about 15 wt. %. Other plasticizers suitable for use with PVOH are known in the art and are contemplated for use in the film described herein.

The plasticized film is flexible. For example, tensile properties can be used as measures of flexibility. One method of measuring tensile properties known in the art is ASTM D 882 “Tensile Properties of Thin Plastic Sheeting.” Thus, in one class of embodiments the flexible film will have a 100% Modulus value in a range of about 500 psi (3.45 MPa) to about 8000 psi (55.2 MPa) (ASTM D-882). In another class of embodiments, the flexible film will have an Ultimate Elongation value in a range of about 100% to about 700% (ASTM D-882). Preferably the flexible film will have both a 100% Modulus in a range of about 500 psi (3.45 MPa) to about 8000 psi (55.2 MPa) and a 100% Modulus in a range of about 500 psi (3.45 MPa) to about 8000 psi (55.2 MPa) (ASTM D-882).

By the tensile properties measure of flexibility, a preferred flexible film will have a 100% Modulus value in a range of about 1000 psi (6.9 MPa) to about 5000 psi (34.5 MPa). A preferred flexible film can also have an Ultimate Elongation value in a range of about 150% to about 400%. Thus, a particularly preferred flexible film will have both a 100% Modulus in a range of about 1000 psi (6.9 MPa) to about 5000 psi (34.5 MPa) and an Ultimate Elongation value in a range of about 150% to about 400%.

Prior hot-water-soluble films based on filly-hydrolyzed PVOH are not impermeable to cold or warm aqueous liquids, and in direct contact the films would take up a considerable amount of water, becoming mechanically weaker in the process, and ultimately allowing the bulk transport of water through the film. By incorporating a sodium montmorillonite nanoclay, for example in an amount up to about 5 wt. % or about 10 wt. %, together with a crosslinking agent such as boric acid and/or water-soluble polyamide-epichlorohydrin, for example in an amount up to about 10 wt % in the film-forming composition, a completely water-impermeable PVOH film can be formed, the film still being flexible and soluble in hot water.

Cold-water-soluble films based on partially-hydrolyzed PVOH resins or other cold-water-soluble resins including copolymers are often used to package unit dose liquid formulations including non-aqueous formulations such as laundry detergents. These films are often prone to “weeping” whereby the substantially non-aqueous liquid seeps through the film and appears on the outside surface. By incorporating, for example, a sodium montmorillonite nanoclay and optionally a crosslinking agent in a partially-hydrolyzed PVOH film-forming composition, a PVOH-based film can be formed which is impermeable to substantially non-aqueous liquids yet still soluble in cold water.

Films based on PVOH resin systems providing intermediate cold/hot water solubility are generally formulated such that they break into pieces in cold water. Such films are used, for example, in flushable applications such as feminine hygiene products and ostomy products. By incorporating, for example, sodium montmorillonite nanoclay and, optionally, a crosslinking agent (such as boric acid) in the film-forming composition, the liquid barrier properties of the films can be significantly enhanced while maintaining the intended breakup in cold water. Such property enhancement can allow more freedom in the choice of a PVOH resin system, for example.

As described above, the film is water soluble and can be tailored for disintegration and/or dissolution at or over a variety of water temperature ranges. By inclusion of a nanoscale particulate as described herein, the film can also. be made impermeable to water and/or other liquids to varying degrees. For example, as described herein a hot-water-soluble film container can be made to directly hold cold or warm aqueous liquids without permeation of the liquid therein.

The film can be useful for a variety of applications wherein water solubility is desired and liquid impermeability is also desired.

In preferred embodiments, generally the film will have a thickness of up to about 250 microns, such as in a range of about 20 microns to about 100 microns, or 75 microns, for example.

For applications such as ostomy, films with improved gas (e.g., odor) barrier properties can be obtained by coating the films of the invention using coating techniques known in the art, including printing-type methods for the deposition of high-barrier organosoluble polymers such as polyvinylidene chloride and ethylene vinyl alcohol. Other coating techniques contemplated include the physical vapor deposition (PVD) techniques of sputtering, cathodic arc evaporation and pulsed laser ablation, and chemical vapor deposition (CVD) methods including the preferred method of plasma enhanced CVD (PECVD). PECVD coating materials contemplated include silicon oxides and silicon-containing polymers. Coatings may be provided on one or both sides of the film. Preferably, such coatings are provided in a thickness that will not otherwise impair the desired characteristics of water solubility or disintegration in water (e.g. flushability). Coatings in the micron and sub-micron range are contemplated (e.g., hundreds of nanometers).

A container made from the film or film composition is also contemplated. The film can be formed into a container, such as a packet, by any means, or the film composition can be made into a container directly. For example, a packet can be formed from two pieces (e.g., webs or sheets) of the film bonded (e.g., to one another) along a periphery, such as by heat sealing, solvent bonding, ultrasonic or dielectric welding, or radio frequency sealing, for example. The containers can be configured in various shapes and with various sealing configurations. The containers can also include one or more openings if the material contained therein is to be dispensed by means other than through disintegration or dissolution of the film.

In other embodiments, a package may be formed from a continuous web of the film that is folded and sealed to itself along a periphery of the folded section. There are a variety of packaging machines which can form and fill such packages from either one or two film webs, for example.

It is contemplated that in one class of embodiments the film container will enclose or contain a liquid therein. For example, the liquid can be aqueous, substantially non-aqueous, or non-aqueous. It is contemplated that the liquid can be in direct contact with at least a portion of the film.

A method of making a water-soluble film is contemplated, the method including the steps of creating a mixture of a hydrophilic nanoscale particulate, a water-soluble polymer, a plasticizer, an aqueous solvent, and, optionally, a crosslinking agent, and then removing the solvent to form a plasticized water-soluble film. A water-soluble polymer and a nanoscale particulate can also be dry blended, and the blend can be mixed with an aqueous solvent.

The components, such as the hydrophilic nanoscale particulate, water-soluble polymer, plasticizer, solvent, and crosslinking agent are preferably included in the mixture in the amounts described above in connection with the preferred embodiments of the composition and film, and alternatively consistent with one or more of the Examples below. The solids content of the composition prior to drying can be in any desired range, for example about 20 wt. % to about 40 wt. %.

Preferably, the method also includes the step of shear mixing the mixture. The shear mixing method can include a step of raising the temperature of a liquid mixture containing the hydrophilic nanoscale particulate, such as raising the temperature of an aqueous solution to about the boiling point. The method can optionally include steps directed towards addition of other film components, mixing, and film-forming. For example, the method can include the step of heating the film-forming composition to drive off solvent.

Film forming operations such as solution casting, blown extrusion, and sheet extrusion are contemplated.

Methods of employing the film and containers made therefrom are also contemplated. The film can be used as a barrier to confine liquids, including aqueous liquids, for example as a container wall or as an entire container made from the film. Thus, the method can include the step of forming at least a portion of a container which, in use, contacts a liquid from a composition of film described herein. The method can also include the step of heating liquid contents of a container made, at least in part, from a water-soluble structure described herein, to a temperature sufficient to dissolve the structure, thereby releasing the liquid contents.

The method can also include the step of contacting a water-soluble structure described herein with water at a temperature sufficient to dissolve the structure. For example, an aqueous component contained in a vessel formed from plasticized water-soluble film described herein can be washed with hot water to dissolve the film and release the aqueous contents.

### EXAMPLES

The following examples are provided for illustration and are not intended to limit the scope of the invention.

### Example 1

A 75 micron thick hot-water-soluble film was prepared from a 30% solids solution in water comprising 4.04 wt. % sodium montmorillonite (CLOISITE NA), 4.98 wt.% water-soluble polyamide-epichlorohydrin resin (POLYCUP 172), 11.8 wt. % glycerin as plasticizer, and 78.68 wt. % fully-hydrolyzed polyvinyl alcohol (ELVANOL 71-30), the balance being surfactants and release agents. The solution was shear mixed for 30 minutes. The film was prepared by casting the solution from a slot die onto a continuous stainless steel belt heated to 85° C. and drying the wet film by passing it through a gas-fired drying oven having two temperature zones set at 450° F. (Zone 1) and 350° F. (Zone 2). Small-angle X-ray scattering(SAXS) studies on this film showed that the nanoclay microstructure was intercalated by virtue of PVOH penetration, with a platelet d-spacing increase of about 50% to about 18Å.The film was formed into a small pouch, which was able to hold 38° C. water for a period of 24 hours without permeation of the water or softening of the film. The film dissolved in approximately 17 seconds in distilled water at 80° C. When suitably formed, the film is useful as a hot water-soluble container for substantially aqueous liquids.

### Example 2

A 75 micron thick hot-water-soluble film was prepared from a 30% solids solution in water comprising 7.15 wt. % sodium montmorillonite (CLOISITE NA), 7.4 wt. % water-soluble polyamide-epichlorohydrin (POLYCUP 172), 11.1 wt. % glycerin as plasticizer, and 74.0 wt. % fully-hydrolyzed polyvinyl alcohol (ELVANOL 71-30), the balance being surfactants and release agents. The solution was shear mixed, raising the temperature from room temperature to about 100° C. and then cooling to about 85° C. The film was prepared by casting the solution, using a doctor blade assembly, onto a stainless steel surface heated to 85° C. and allowing the wet film to dry for about 10 minutes. The film was formed into a small pouch, which was able to hold 38° C. water for a period of 24 hours without permeation of the water or softening of the film. The film dissolved in approximately 35 seconds in distilled water at 80° C. When suitably formed, the film is useful as a hot water-soluble container for substantially aqueous liquids.

### Example 3

A 75 micron thick hot-water-soluble film was prepared from a 30% solids solution in water comprising 10.1 wt. % sodium montmorillonite (CLOISITE NA), 5.1% boric acid, 12.1 wt. % glycerin as plasticizer, and 72.4 wt. % fully-hydrolyzed polyvinyl alcohol. (ELVANOL 71-30), the balance being surfactants and release agents,. The solution was shear mixed, raising the temperature from room temperature to about 100° C. and then cooling to about 85° C. The film was prepared by casting the solution, using a doctor blade assembly, onto a stainless steel surface heated to 85° C. and allowing the wet film to dry for about 10 minutes. The film was formed into a small pouch, which was able to hold 38° C. water for a period of 24 hours without permeation of the water or softening of the film. The film dissolved in approximately 25 seconds in distilled water it 80° C. When suitably formed, the film is useful as a hot water-soluble container for substantially aqueous liquids.

### Example 4

A 75 micron thick cold water soluble film was prepared from a 38 wt. % solids solution in water comprising 4.0 wt. % sodium montmorillonite (CLOISITE Na), 14.7 wt. % glycerin as plasticizer, and 60.0 wt. % of a carboxylate-modified polyvinyl alcohol, the balance being surfactants, extenders and release agents. The solution was shear mixed, raising the temperature from room temperature to about 100° C. and then cooling to about 85° C. The film was prepared by casting the solution, using a doctor blade assembly, onto a stainless steel surface heated to 85° C. and allowing the wet film to dry for about 10 minutes. The film was placed on top of a 100 ml beaker containing 60 ml of propylene glycol and was secured tightly under the lip of the beaker using a rubber band such that the film was taut across the top. The beaker was inverted and held in a laboratory clamp for 24 hours. After this. time, no permeation, softening or sagging of the film was observed. The weight gain of the film in the exposed area due to uptake of propylene glycol was determined to be 9%. A similar experiment using a film containing no sodium montmorillonite resulted in noticeable softening and sagging of the film after 24 hours. The weight gain of the film in the exposed area due to uptake of propylene glycol was determined to be 30%. The sodium montmorillonite-containing film dissolved in 130 seconds in distilled water at 10° C. The film is useful as a cold water-soluble unit dose packaging film for liquid formulations that permeate through conventional polyvinyl alcohol films.

### Example 5

A 75 micron thick warm water-soluble film was prepared from a 30% solids solution in water comprising 4.0 wt. % sodium montmorillonite (CLOISITE Na), 13.3 wt. % glycerin as plasticizer, 18.0 wt. % of a polyvinyl alcohol having a degree of hydrolysis of 96% (CELVOL 425), and 54.0 wt. % of a polyvinyl alcohol having a degree of hydrolysis of 98% (MOWIOL 20-98), the balance being a modified starch (11.0 wt. %), surfactants, and release agents. The solution was shear mixed, raising the temperature from room temperature to about 100° C. and then cooling to about 85° C. The film was prepared by casting the solution, using a doctor blade assembly, onto a stainless steel surface heated to 85° C. and allowing the wet film to dry for about 10 minutes. The film was formed into a small pouch which was able to hold 38° C. water for a period of 24 hours without permeation of the water or softening of the film. The film broke up into pieces in approximately 10 minutes when moderately agitated in distilled water at 21° C. When suitably formed, the film is useful in cold water-flushable applications, such as ostomy bags, bedpan liners, and commode liners.

The foregoing description is given for clearness of understanding only, and no unnecessary limitations should be understood therefrom, as modifications within the scope of the invention may be apparent to those having ordinary skill in the art.

Embodiments of the films and containers herein can have one or more of several advantages over prior water-soluble films used for holding liquids. for example, prior films have included one or more coatings of water-insoluble materials, whereas such coatings are optional when using the film described herein. Obviously, omitting secondary coating operations allows for simplification and efficiency of manufacturing processes. In addition, there is often a significant technical challenge in providing such coatings on water-soluble films, because such coatings are generally required to disintegrate into particulate form when the water-soluble film is dissolved in its end use or in its disposal, yet the coating must also provide the required liquid barrier properties for a particular application. Omission of secondary coatings can eliminates potential problems from residual particulate matter from such coatings following dissolution of the film.

Throughout the specification, where compositions and films are described as including components or materials, it is contemplated that the compositions and films can also consist essentially of, or consist of, any combination of the recited components or materials, unless described otherwise. For example, a water-soluble film consisting of or consisting essentially of a water-soluble polymer such as PVOH, a plasticizer, a hydrophilic nanoscale particulate such as a nanoclay, a crosslinking agent for the polymer, and optionally one or more other fillers or auxiliary agents, is contemplated.

The practice of a method disclosed herein, and individual steps thereof, can be performed manually an/or with the aid of electronic equipment. Although processes have been described with reference to particular embodiments, a person of ordinary skill in the art will readily appreciate that other ways of performing the acts associated with the methods may be used. For example, the order of various of the steps may be changed without departing from the scope or spirit of the method. In addition, some of the individual steps can be combined, omitted, or further subdivided into additional steps.

1. A composition, comprising: a flexible, water-soluble, homogeneous film, said film comprising a water-soluble polymer, a hydrophilic nanoscale particulate, and a plasticizer.

2. A film according to claim 1, wherein said water-soluble polymer is polyvinyl alcohol.

3. A film according to claim 2, wherein said polyvinyl alcohol is fully hydrolyzed.

4. A film according to claim 2, wherein said polyvinyl alcohol has a degree of hydrolysis of about 70% to 100%.

5. A film according to claim 1, wherein said hydrophilic nanoscale particulate is selected from the group consisting of smectite clays, modified versions thereof, and combinations of the foregoing.

6. A film according to claim 1, wherein said hydrophilic nanoscale particulate is selected from the group consisting of bentonites, montmorillonites, saponites, hectorites, beidellites, nontronites, modified versions thereof, and combinations of the foregoing.

7. A film according to claim 6, wherein said hydrophilic nanoscale particulate is a montmorillonite.

8. A film according to claim 7, wherein said hydrophilic nanoscale particulate is a sodium montmorillonite.

9. A film according to claim 1, wherein said hydrophilic nanoscale particulate is present in an amount of about 1% to about 10%, based on the weight of the film.

10. A film according to claim 9, wherein said hydrophilic nanoscale particulate is present in an amount of about 1% to about 5%, based on the weight of the film.

11. A film according to claim 10, wherein said hydrophilic nanoscale particulate is present in an amount of about 1% to about 4%, based on the weight of the film.

12. A film according to claim 1, further comprising a crosslinking agent for said water-soluble polymer.

13. A film according to claim 12, wherein said crosslinking agent is selected from borates, boric acid, ammonium zirconium carbonate, inorganic polyions, Group 1B salts, water-soluble polyamide-epichlorohydrin resin, and combinations thereof.

14. A film according to claim 13, wherein said crosslinking agent is selected from boric acid, and water-soluble polyamide-epichlorohydrin resin, and combinations thereof.

15. A film according to claim 14, wherein said crosslinking agent is water-soluble polyamide-epichlorohydrin resin.

16. A film according to claim 12, wherein said crosslinking agent is present in an amount of about 1% to about 10%, based on the weight of the film.

17. A film according to claim 1, further comprising a gas barrier coating.

18. A film according to claim 17, wherein said gas barrier coating comprises a material selected from the group consisting of silicon oxides, silicon-containing polymers, and combinations thereof.

19. An article, comprising: a container made at least in part from a film according to claim 1, the container containing a liquid, said film in direct contact with said liquid.

20. In a plasticized water-soluble film container used for holding a liquid, the improvement comprising inclusion in the film of a hydrophilic nanoscale particulate.

21. The improvement of claim 20, further comprising inclusion in the film of a film crosslinking agent.

22. A method comprising the steps of:
confining a liquid with a flexible, water-soluble, homogeneous film, said film comprising a water-soluble polymer, a hydrophilic nanoscale particulate, and a plasticizer, and then
contacting said film with water at a temperature sufficient to dissolve said film, thereby releasing said confined liquid.

23. The method of claim 22, wherein said film further comprises a crosslinking agent for said polymer.
